(19) United States
(12) Patent Application Publication
(10) Pub. No.: US 2021/0059491 A1
(43) Pub. Date: Mar. 4, 2021

(54) VACUUM ATTACHMENT FOR REMOVING AIRBORNE DUST PARTICLES

(71) Applicant: KACH HOLDINGS, LLC, Greensboro, NC (US)

(72) Inventor: Craig E. HACKER, Monroe, NC (US)

(21) Appl. No.: 17/096,400

(22) Filed: Nov. 12, 2020

Related U.S. Application Data
(63) Continuation of application No. 16/011,805, filed on Jun. 19, 2018.

(51) Int. Cl. A47L 7/00; A47L 9/06

(52) U.S. Cl. CPC A47L 7/0095; B23Q 11/0046; A47L 9/0693

(57) ABSTRACT

The invention comprises a vacuum attachment with multiple ports which easily attaches to an open top container to remove concrete/mortar dust and particulates from the air when mixing concrete/mortar with water. The vacuum attached in configured to fit securely on a variety of containers of different sizes. Further, the vacuum attachment attaches easily to any standard vacuum machine. The vacuum attachment may have lateral segments which provide spacing for two curved portions which terminate in multiple ports. The curved portions may be positioned at the top of the container with the ports facing downward into the container. When a vacuum machine is attached and activated, the vacuum attachment is able to efficiently remove dust particles from the air inside the container. Multiple vacuum attachments may also be used simultaneously by connecting a Y splitter hose to each of the vacuum machine attachment ports of the vacuum attachments.

### CROSS REFERENCE TO RELATED APPLICATIONS

This application is a continuation of co-pending U.S. patent application Ser. No. 16/011,805, filed Jun. 19, 2018, entitled “Vacuum Attachment for Removing Airborne Dust Particles,” the entire contents of which are incorporated by reference herein.

### BACKGROUND OF THE INVENTION

The invention is related to a vacuum cleaner attachment for use in industrial applications to reduce and eliminate crystalline silica in cement and similar dust particles from the air when mixing cement and other dry powdery substances in an open top container. The purpose of the invention is to improve the air quality of individuals working with the cement or other substances and reduce the amount of inhalable particles in the air.

Crystalline silica is a mineral that is commonly found in construction materials. Crystalline silica is typically found in materials such as sand and stone and products made with these materials. When these materials are cut, crushed and otherwise processed, they can release very small particles of crystalline silica which can cause very serious health problems for workers who inhale these particles, including chronic obstructive pulmonary disease and cancer.

For this reason, the Occupational Safety and Health Administration (OSHA) sets forth standards regulating employers to limit the amount of exposure of crystalline silica to workers. The OSHA standard, set forth in 29 C.F.R. § 1926.1153, requires employers to enact various dust reducing measures on equipment and work environment if an “action level” is reached. The action level is defined as a concentration of airborne respirable crystalline silica of 25 μg/m³, calculated as an 8-hour time weighted average. Where employee exposure reaches the action level, an employer following this standard must implement dust reducing methods as directed for the identified construction activities. For instance, where a worker utilizes a stationary masonry saw, the saw should be equipped with an integrated water delivery system that continuously feeds water to the blade in order to reduce dust emissions. Where jackhammers are in use, the employer may utilize a water delivery system to reduce dust or a shroud and dust collection system. Alternately, under OSHA standards, an employer may choose to regulate employees' exposure to inhalable crystalline silica over and eight hour period and ensure that their exposures do not exceed the permissible exposure limit (PEL) of 50 μg/m³ as an 8-hour time weighted average. Where the PEL exceeds the permissible exposure limit, the employer must implement means to reduce the exposure which may include respirators. The health dangers associated with exposure to crystalline silica are apparent and demonstrate a serious concern to workers in the various construction industries.

Cement is composed primarily of crystalline calcium silicates that react with water (H₂O) to form calcium silicate hydrates which have a base formula Ca₂SiO₅H₂— or C—S—H as it is typically termed within with the concrete industry. There are various formulations of cement but the basic components involve the main reaction of water with a form of crystalline calcium silicate to create the C—S—H molecule. Concrete incorporates cement and is comprised of a fine aggregate, such as sand, and a coarse aggregate, such as gravel, mixed with a hydraulic cement. Grouts and mortars are comprised of a fine aggregate, such as sand, mixed with hydraulic cement. The combination of these elements is then permitted to “cure,” allowing the chemical reactions of the components to form interlocking calcium silicate hydrates—the C—S—H bond.

Workers in the masonry industry are typically required to mix a concrete/mortar mixture with water to be used in building materials. Cement mortar is used to maintain, repair and rehabilitate structures, and concrete is used to form the main structural and load bearing component of many building structures. The concrete or mortar cement mixture is often sold as a powdery substance which, when mixed with water, forms a paste, and the mixture starts the “curing” and hardening process. However, prior to the introduction of water, as workers are handling the powdered cement mortar and concrete mixtures, the workers become exposed to particles of crystalline silica as they add the concrete/mortar cement mix to the mixing container. As the concrete/mortar cement mix is added to the container, some of the powder becomes airborne. Such airborne particles are easily inhaled and create substantial health risks to the workers mixing the concrete and mortar cement mixture formulations.

Additionally, workers at construction sites often work outside in uncontrolled conditions. For instance, containers for mixing concrete and mortar are often open at a top end, and as concrete/mortar mix is poured into the top of the container, most of the concrete/mortar powder falls to the bottom of the container, but a portion of the concrete/mortar powder floats into the air where workers inhale the airborne particles, including crystalline silica.

The prior art addresses several means to reduce workers' exposure to airborne particles. OSHA regulations provide various means by when employers may create a safer work environment including implementation of filtration systems, using water to reduce the amount of airborne dust when sawing and cutting, and providing adequate ventilation. However, these safety precautions work best in a controlled environment. For instance, when cutting, water may be applied directly to the point where the saw blade contacts the material being cut. In a manufacturing facility, a worker may be enclosed in a booth designed to prevent the migration of dust particles. Ventilation systems typically require a closed system to adequately remove dust from the air. These systems are difficult to implement in an uncontrolled environment where workers are simply mixing concrete/mortar in open containers. Further, the dust removal systems recommended by OSHA standards require substantial financial capital to implement which may be cost prohibitive to smaller companies.

Accordingly, there is a need for an easily utilized and effective means of controlling dust and concrete/mortar powder containing crystalline silica when workers are handling these substances in uncontrolled environments. Removing the powder and dust from the air by creating a vacuum is an easily implemented and efficient means to reduce the amount of airborne crystalline silica. The prior art contains numerous examples of vacuum cleaners and vacuum cleaner attachments for use in cleaning floors in a residential environment. The vacuum equipment of the prior art typically utilizes a single intake port for drawing air into the vacuum machine, and most attachments are configured to be placed on a flat surface, such as a floor, so that the attachment can be pressed firmly against the flat surface on all sides creating vacuum suction within the attachment. The intake port of these attachments is typically configured in a plane to be pressed against the flat surface and the opening generally measures approximately 12 inches by 6 inches. When pressed against a flat surface, this configuration creates a vacuum suction sufficient to remove dust and dirt from the surface.

Additionally, in the prior art, vacuum machines sometimes utilize a vacuum hose with a single intake port for cleaning objects and dust in an area directly in front of the hose. These types of machines are useful in a “shop” environment to clean and remove an accumulation of larger objects which have settled to the floor, for example particles of sawdust. The small diameter of the single intake port of this type of attachment allows a sufficient amount of vacuum suction to build within the intake port to move objects. However, the vacuum machine is typically only able to clean and remove objects directly in front of the hose. When applied to vacuum particles from the air, the single intake port of the vacuum hose is insufficient to remove significant quantities of particles from the air.

Further, when applied to the construction industry, the prior art devices are not useful to remove concrete/mortar dust particulates from the air when mixing concrete/mortar in open top containers. A single port vacuum is able only to create suction and remove particles from an area directly in front of the intake port. Accordingly, significant amounts of concrete/mortar dust will still escape the single port vacuum and workers are still be exposed to dangerous crystalline silica in the air when mixing concrete/mortar. The prior art also contains examples of use of a single vacuum hose to attempt to remove dust from the air. An example of such configuration is a single port vacuum attachment sold under the trade name WaleTale® in which a single vacuum hose is attached to the side of an open top container. This configuration requires a clip which is specific to a particular sized standard sized container. Additionally, the single port vacuum hose is directed toward the plane of the top of the container, not downward into the container. Further, heavy weight from the bag movement could knock it loose during use and does not allow for laying the heavy bag across the device without knocking it loose from the container or breaking the device.

However, as is discussed herein, the subject invention significantly and more effectively removes airborne particles than a single vacuum hose, and the subject invention provides a significant improvement in terms of health advantages over the prior art. The device of the invention contains two intake tubes which, not only serve to gather more powder and dust, but also provide increased stability and provide balance to the vacuum attachment device when it is placed on any round open top container. It is not dependent on the mixing cylinder having a standard pail rim design nor is it limited for use solely with commercial mixing drums.

Additionally, construction workers typically use a drum, a 5 gallon pail, or other cylindrical container with a bottom, cylindrical sides and an open top, to mix concrete and cement mortar powders with water. Single port vacuum hoses are not configured to be positioned in place on the container, in order to enable any kind of advantage by vacuuming the concrete/mortar dust from the air, the worker would need to devise a means to attach the vacuum hose to the container, or employ a second person to hold the vacuum hose, so that the vacuum hose remained in place while he mixed the materials. The process would be time consuming and inefficient. Accordingly, there remains a need for a practical and efficient means to remove dust particulate from the air in open top containers to improve air quality for workers in the construction industry.

It is an object of the invention to provide a multiple port vacuum attachment for easy removal of concrete and cement mortar powder dust particles from the air when mixing powdered concrete/mortar with water in open top containers. It is a further object of the invention to provide a vacuum machine attachment which easily attaches to different sized open top containers. It is a further object of the invention to provide a vacuum machine attachment which attaches and is readily interchangeable with most standard vacuum machines. The present invention overcomes the limitations of the prior art by providing for a device which accomplishes the objects of the invention.

### SUMMARY OF THE INVENTION

The invention comprises a vacuum attachment with multiple ports which easily attaches to an open top container to remove concrete/mortar dust and particulates from the air when mixing concrete/mortar with water. In a preferred embodiment, the attachment contains two ports which are spaced so that the intake ports draw a larger volume of air and so that the attachment remains stable on the side of the container.

The vacuum attachment of the invention, comprises a device which attaches easily to any standard vacuum machine and rests securely on the edge of an open top container. In a preferred embodiment, the attachment comprises a tubular vacuum machine attachment port which may slide over a vacuum intake hose of a vacuum machine.

The vacuum machine attachment port may be connected to a first intake tube and a second intake tube to draw air from different positions simultaneously. The first intake tube may be comprised of a first lateral segment which is positioned generally perpendicular to the vacuum machine attachment port at the point of attachment. The lateral segment should be of sufficient length to provide a distance between intake ports.

The first and second intake tubes may be further configured to form curved portions which may rest on the top of an open top container and be held securely in position. The curved portions may terminate in first and second intake ports each positioned downward toward the interior of the container. Each of the segments of the first and second intake tubes should be pneumatically connected to permit the flow of air to enter the intake ports, travel through the hooks, the risers, and lateral segments and then through the vacuum machine attachment port and into a vacuum machine.

Additionally, multiple vacuum attachments may also be used simultaneously by connecting a Y splitter hose to each of the vacuum machine attachment ports of the vacuum attachments.

### BRIEF DESCRIPTION OF THE DRAWINGS

FIG. 1 shows a perspective view of a vacuum attachment according to the invention;

FIG. 2 shows a right-side elevational view of a vacuum attachment according to the invention;

FIG. 3 shows a left-side elevational view of a vacuum attachment according to the invention;

FIG. 4 shows a front elevational view of a vacuum attachment according to the invention;

FIG. 5 shows a bottom plan view of a vacuum attachment according to the invention;

FIG. 6 shows a top plan view of a vacuum attachment according to the invention;

FIG. 7 shows a perspective view of a system for removal of concrete/mortar powder dust particulates from an open top container according to the invention; and

FIG. 8 shows a perspective view of an alternate embodiment of a system for removal of concrete/mortar powder dust particulates from an open top container according to the invention.

### DETAILED DESCRIPTION OF THE INVENTION

The invention comprises a vacuum attachment with multiple ports which easily attaches to an open top container to remove concrete/mortar dust and particulates from the air when mixing concrete/mortar with water. In a preferred embodiment, the attachment contains two ports which are spaced so that the intake ports draw a larger volume of air and so that the attachment remains stable on the side of the container. The vacuum attachment may be constructed of a lightweight but stable material, for example, plastic, PVC or a metallic material.

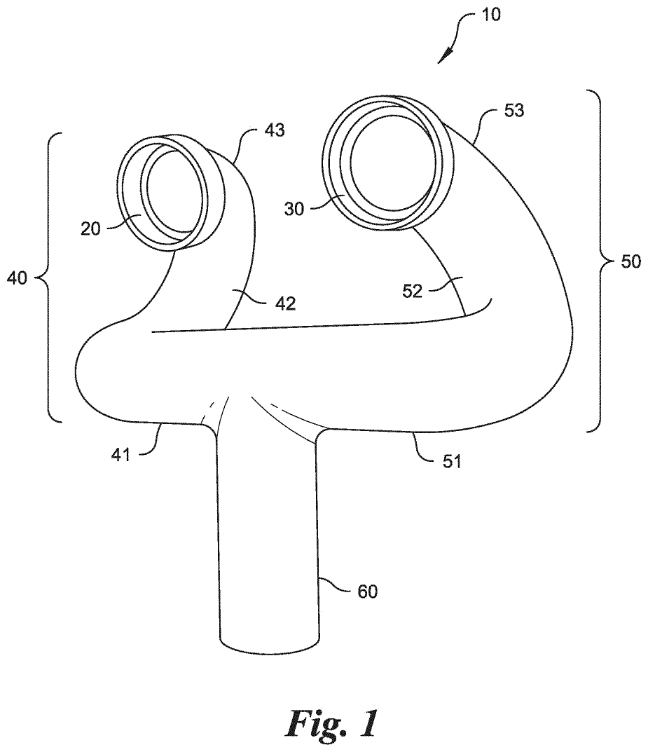

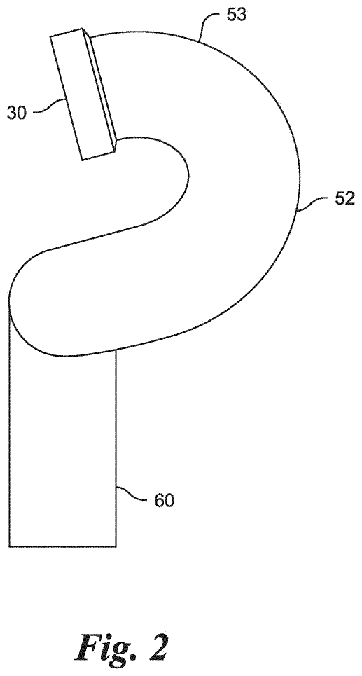

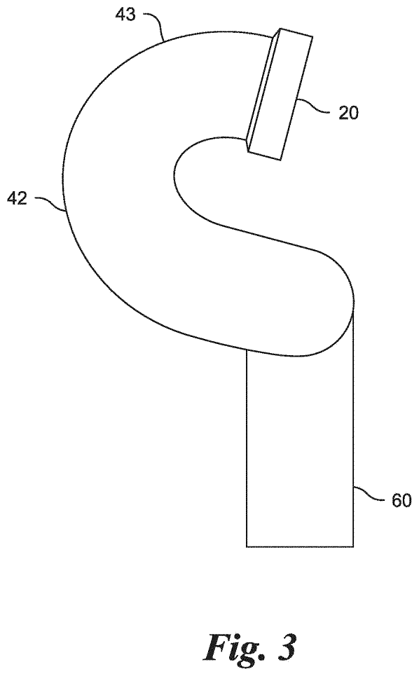

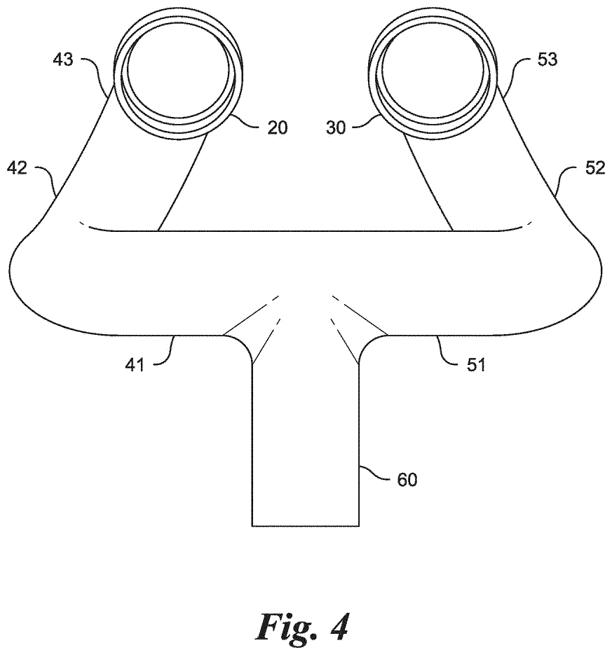

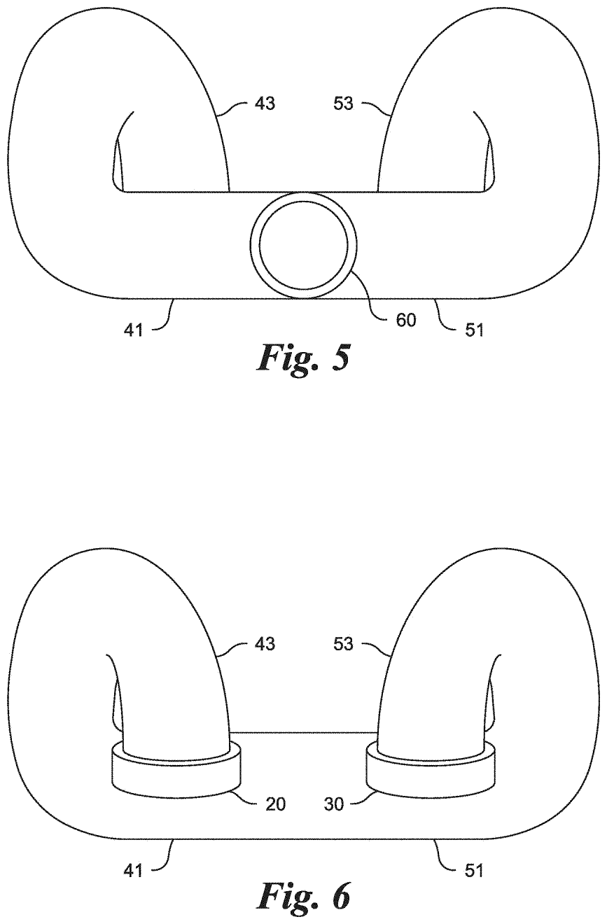

As shown in FIGS. 1-6, the vacuum attachment 10 of the invention comprises a device which attaches easily to any standard vacuum machine and rests securely on the edge of an open top container. In a preferred embodiment, the attachment 10 comprises a tubular vacuum machine attachment port 60 which may slide over a vacuum intake hose of a vacuum machine. Typically, a vacuum machine hose 100 is tapered so as to be narrower at the intake opening and so the attachment 10 may be secured to the vacuum machine intake hose 100 by pressing the vacuum machine attachment port 60 firmly onto the vacuum machine hose 100. In a preferred embodiment, the inside diameter of the vacuum machine attachment port 60 may be from 1″ to 3″ and in a most preferred embodiment, the inside diameter may be 1⅝″.

The vacuum machine attachment port 60 may be connected to a first intake tube 40 and a second intake tube 50 to draw air from different positions simultaneously. The first intake tube 40 may be comprised of a first lateral segment 41 which is positioned generally perpendicular to the vacuum machine attachment port 60 at the point of attachment. The lateral segment 41 should be of sufficient length to provide a distance between intake ports 20 and 30.

The first intake tube 40 may be further configured to form a curved portion which may rest on the top of an open top container 130 and be held securely in position. The curved portion may be connected to the lateral segment 41 and configured to rest on the top of an open top container 130 and engage the container. The curved portion may further comprise a riser 42 of generally straight tubing and a first hook 43 to engage the top of the container, and the first intake tube 40 may terminate at the first intake port 20. The first hook 43 may curve approximately 180° such that the first intake port 20 is positioned downward toward the interior of the container, while the other end of the hook 43 faces downward on the outside of the container connected to the riser 42. Each of the segments of the first intake tube 40 should be pneumatically connected to permit the flow of air to enter the first intake port 20, travel through the first hook 43, riser 42, and lateral segment 41 and then through the vacuum machine attachment port 60 and into a vacuum machine 120.

The second intake tube 50 may be configured in a similar manner. The second intake tube 50 may be comprised of a second lateral segment 51 which is positioned generally perpendicular to the vacuum machine attachment port 60 at the point of attachment, opposite the first intake tube 40. The second lateral segment 51 should be of sufficient length to provide a distance between intake ports 20 and 30.

The second intake tube 50 may be further configured to form a curved portion which may rest on the top of the open top container 130 and be held securely in position. The curved portion may be connected to the second lateral segment 51 and be configured to rest on the top of the open top container 130 and engage the container. The curved portion may further comprise a second riser 52 of generally straight tubing and a second hook 53 portion to engage the top of the container, and the second intake tube 50 may terminate at the second intake port 30. The second hook 53 may also be curved approximately 180° such that the second intake port 30 is positioned downward toward the interior of the container, while the other end of the hook 53 faces downward on the outside of the container connected to the second riser 52. Each of the segments of the second intake tube 50 should be pneumatically connected to permit the flow of air to enter the second intake port 30, travel through the second hook 53, second riser 52, and second lateral segment 51 and then through the vacuum machine attachment port 60 and into the vacuum machine 120.

In a preferred embodiment, first and second lateral segments, 41 and 51, of the first and second intake tubes, 40 and 50, may extend approximately 10¾″ (about 5″ from the vacuum machine attachment port 60 on either side). The first and second risers, 41 and 51, of the first and second intake tubes, 40 and 50, may be spaced such that the outside walls of the two risers are spaced approximately 10¾″ apart and the inside walls of the two risers are spaced approximately 6⅛″ apart. The first and second intake ports, 20 and 30, may have outside diameters of about 2¼″ and inside diameters of about 2″. The outside dimensions of the first and second intake ports 20 and 30, may be spaced approximately 10¾″ apart. The outside dimensions of the downward facing ends of the first hook 43 may be approximately 5¾″ apart, and the inside dimensions may be space at approximately 1⅜″. The downward facing ends of the second hook 53 may be spaced in a similar manner.

When the first and second hooks, 43 and 53, are placed onto the top of an open top container, the 1⅜″ clearance between the ends of the two hooks provides sufficient stability to hold the vacuum attachment in position yet sufficient flexibility to be able to be positioned on containers of various sizes. Of course, the invention contemplates that this distance may be modified as needed for different sized containers. Alternate embodiments of the attachment may provide spacing between the inside dimensions of the ends of the first and second hooks between 1″ and 3″.

The preferred dimensions permit the vacuum attachment to connect easily to a standard vacuum hose and to rest on the top of open top containers of various dimensions. In practice, the vacuum attachment is stable when attached to a 55 gallon drum as well as a 2.5 gallon pail. Importantly, the vacuum attachment extracts airborne concrete/mortar powder, but does not extract or affect the concrete/mortar powder at the bottom of the container and does not alter the proper ratio of water to concrete/mortar mixture.

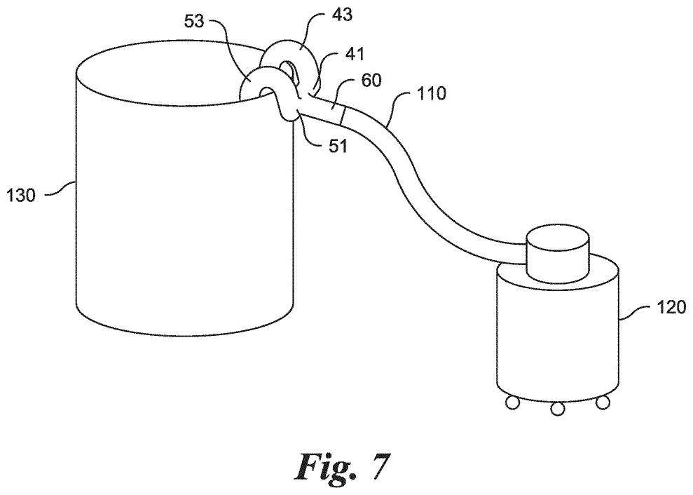

As demonstrated in FIG. 7, in operation, a worker may position the vacuum attachment to a vacuum machine as indicated and rest the vacuum attachment on the edge of an open top container 130 with the first and second intake ports, 20 and 30, facing downward into the container. Preferably, the first and second intake ports should be positioned close to the top of the container but with sufficient depth into the container so that the vacuum attachment remains securely positioned on the container. The worker may then activate the vacuum machine to create suction throughout the vacuum attachment and through the first and second intake ports, 20 and 30. The worker may then pour a powdered concrete or cement mortar mixture into the container, which, in the process of pouring, will create airborne concrete/mortar dust within the container. However, rather than escaping the container, the concrete/mortar dust will be drawn toward and into the first and second intake ports, 20 and 30 of the vacuum attachment 10, through a vacuum machine hose 110, and into the vacuum machine 120. In this manner, the vacuum attachment effectively removes most of the concrete/mortar dust before it escapes the container, and the workers will not inhale dangerous crystalline silica, and other harmful components, within the concrete/mortar powder. Of course, the vacuum attachment may be used to remove other harmful airborne particles when positioned on an open top container, regardless of the industry.

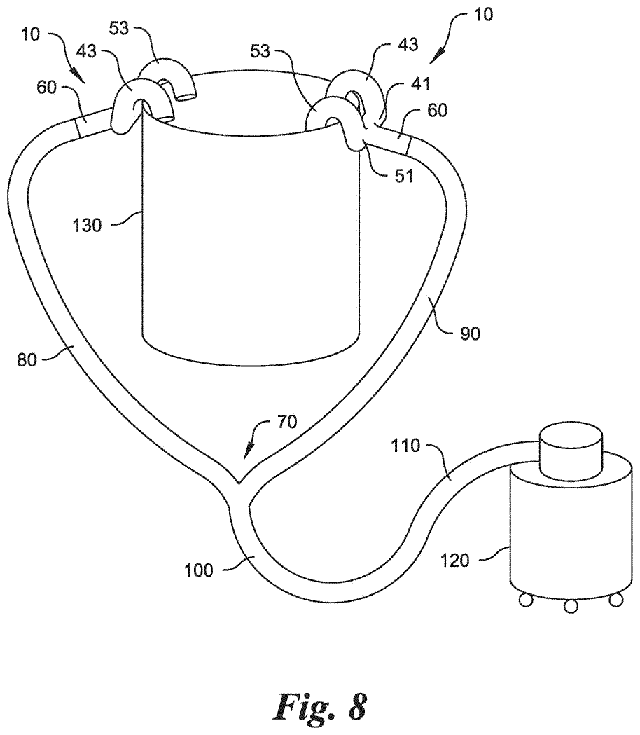

Multiple vacuum attachments may also be used simultaneously by connecting a Y splitter hose 70 to each of the vacuum machine attachment ports 60 of the vacuum attachments 10. As shown in FIG. 8, the Y splitter hose may comprise a first and a second Y-splitter intake hoses, 80 and 90, connected to a Y splitter vacuum hose 100. The Y splitter vacuum hose 100 may connect to a vacuum machine hose 110 of a vacuum machine 120. The first and second Y-splitter intake hoses, 80 and 90, may attach to the vacuum machine attachment ports 60 of two separate vacuum attachments 10 which may be positioned on opposite sides of an open top container 130 creating four intake ports within the container to remove airborne dust particles from different areas of the container.

In operation, when the vacuum machine 120 is activated, air is drawn through the vacuum attachments, through Y splitter intake hoses, 80 and 90 and into Y splitter vacuum hose 100, then into the vacuum machine hose 110 and into the vacuum machine 120. In this manner, more than one vacuum attachment may be used to remove airborne dust and prevent the dust from escaping larger containers when powdered concrete/mortar or another powder is poured into the container.

### Testing Data

The subject invention, with two intake ports, has been tested for effectiveness and efficiency in comparison with single port vacuum machine attachments. Additionally, the first and second intake ports of the invention, and the intake ports of single port attachments, were tested at two diameters at 1½″ and 2″. In each test, the inventors poured 40 pounds of prepackaged powder at the same pour rate into a commercial five (5) gallon pail (an open top container). In each test, the specified vacuum attachment was placed and secured at the top of the five gallon pail, and the specified vacuum attachment was connected to a Shop-Vac® 8 gallon capacity, 6.0 Peak HP, 75 cubic feet per minute vacuum. Results were measured by the amount in grams of airborne dust particles collected utilizing the various vacuum attachments.

The vacuum attachment of the subject invention was a dual port vacuum attachment and contained two intake tubes connected to lateral segments which connected to a vacuum hose and vacuum machine as described herein. The vacuum attachment of the subject invention was also compared with a single port vacuum attachment constructed with a hook and an intake port facing downward into the container, except that only one intake tube connected to the vacuum. Finally, the inventive vacuum attachment was compared to a commercially available single port vacuum attachment sold under the trade name WaleTale® in which a single vacuum hose is attached to the side of an open top container. The WaleTale® configuration requires a clip which is specific to a particular sized container, e.g. a clip may be designed to fit a five gallon pail but will not fit any other sized pail. Another sized pail would require a different sized clip. Additionally, in the WaleTale® configuration, the single port vacuum hose is directed toward the plane of the top of the container, not downward into the container. Further, the WaleTale® configuration only fits on standard pail rims and is directed sideways making it difficult not to pour powder directly into the vacuum attachment. Heavy weight from the bag movement could knock it loose during use and does not allow for laying the heavy bag across the device without knocking it loose from the container or breaking the device.

Testing Provided the Following Results:

| | Amount of Dust | |
|---|---|---|
| Design Configuration | Collected (g) | |
| 1½″ Dual Port Attachment of The Invention | 13 | grams* |
| 2″ Dual Port Attachment of The Invention | 10 | grams |
| 1½″ Single Port Attachment | 4 | grams |
| (with intake port facing downward into the container) | | |
| 2″ Single Port | 4 | grams |
| (with intake port facing downward into the container) | | |
| WaleTale ® Open Market | 3 | grams |

*Average of two trials

The configuration of the invention, with two intake ports facing downward into the container and intake ports spaced so as to provide a wider dust collection “area” at the top of the container, provided superior results. Further, a single port attachment with intake port facing downward into the container provided superior results over the WaleTale®. configuration in which the intake port is directed toward the plane of the top of the container and not downward into the container. In the two port attachment of the invention, intake ports with inside diameters of 1½″ provided the best results and are preferred embodiments of the invention.

The subject invention fulfills the objects of the invention by providing a multiple port vacuum attachment for easy removal of concrete and cement mortar powder dust particles from the air when mixing powdered concrete/mortar with water in open top containers which easily attaches to different sized open top containers. The invention further provides a vacuum machine attachment which attaches and is readily interchangeable with most standard vacuum machines. Testing shows the attachment of the invention to provide superior results over the prior art and overcomes the limitations of the prior art by providing a more effective device which is easier to use, more economical, and more versatile than the prior art devices.

The invention has been disclosed in terms of preferred embodiments which fulfill all of the objects of the present invention and overcome the limitations of the prior art. Various changes, modifications, and alterations from the teachings of the present invention may be contemplated by those skilled in the art without departing from the intended spirit and scope thereof. It is intended that the present invention only be limited by the terms of the appended claims.

I claim:

1. A vacuum attachment formed of a generally rigid material and configured to remove airborne dust particles, the vacuum attachment comprising:
a tubular vacuum attachment port;
a first intake tube pneumatically coupled to the tubular vacuum attachment port to permit the flow of air through the first intake tube and into the tubular vacuum attachment port, the first intake tube comprising a first lateral segment positioned generally perpendicular to the tubular vacuum attachment port, a first riser of generally straight tubing extending vertically upward and away from the first lateral segment, and a first hook segment comprised of generally curved tubing configured to engage the top of an open top container, the first hook segment extending away from the first riser and continuing vertically downward terminating in a first intake port, the first intake port being spaced apart from the first riser; and
a second intake tube pneumatically coupled to the tubular vacuum attachment port to permit the flow of air through the second intake tube and into the tubular vacuum attachment port, the second intake tube comprising a second lateral segment positioned generally perpendicular to the tubular vacuum attachment port, a second riser of generally straight tubing extending vertically upward and away from the second lateral segment, and a second hook segment comprised of generally curved tubing configured to engage the top of the open top container, the second hook segment extending away from the second riser and continuing generally vertically downward terminating in a second intake port, the second intake port being spaced apart from the second riser.

2. The vacuum attachment of claim 1, wherein the outside dimensions of the first riser and the downwardly extending portion of the first hook segment are spaced apart about 5¾″ and the inside dimensions of the first riser and the downwardly extending portion of the first hook segment are spaced apart about 1⅜″.

3. The vacuum attachment of claim 2, wherein the outside dimensions of the second riser and the downwardly extending portion of the second hook segment are spaced apart about 5¾″ and the inside dimensions of the second riser and the downwardly extending portion of the second hook segment are spaced apart about 1⅜″.

4. The vacuum attachment of claim 1, wherein the generally rigid material is plastic.

5. The vacuum attachment of claim 4, wherein the plastic is polyvinylchloride (PVC).

6. The vacuum attachment of claim 1, wherein the generally rigid material is metal.

7. The vacuum attachment of claim 1, wherein first lateral segment extends about 5″ from the tubular vacuum attachment port and the second lateral segment extends about 5″ from the tubular vacuum attachment port.

8. The vacuum attachment of claim 1, wherein the first and second risers of the first and second intake tubes are spaced apart so that outside walls of the first and second risers are spaced about 10¼″ apart and the inside walls of the first and second risers are spaced about 6⅛″ apart.

9. The vacuum attachment of claim 1, wherein the first intake port and the second intake port are spaced about 10¼″ apart from each other.

10. The vacuum attachment of claim 1, wherein the first and second intake ports each have an outside diameter of about 2¼″ and each have an inside diameter of about 2″.

11. The vacuum attachment of claim 1, wherein the inside diameter of the tubular vacuum attachment port is between about 1″ and 3″.

12. The vacuum attachment of claim 1, wherein the first hook segment is curved approximately 180° such that when placed on an open top container, the first intake port is positioned facing downward toward an inside wall of the container and the first riser extends downward on an outside wall of the container, and the second intake port is positioned facing downward toward the inside wall of the container and the second riser extends downward on the outside wall of the container.
